(19) United States
(12) Patent Application Publication
(10) Pub. No.: US 2005/0091023 A1
(43) Pub. Date: Apr. 28, 2005

(54) Fuel cell simulator, simulation result display method, and computer program product

(75) Inventors: Makoto Fujiuchi, Toyota-shi (JP); Atsushi Ida, Nissin-shi (JP); Katsuhiko Kinoshita, Nissin-shi (JP); Katsuya Matsuoka, Toyota-shi (JP); Masahiko Morinaga, Toyota-shi (JP)

Correspondence Address: OLIFF & BERRIDGE, PLC, P.O. BOX 19928, ALEXANDRIA, VA, 22320, US

(73) Assignee: TOYOTA JIDOSHA KABUSHIKI KAISHA, Toyota-shi (JP)

(21) Appl. No.: 10/940,753

(22) Filed: Sep. 15, 2004

(30) Foreign Application Priority Data
Sep. 30, 2003 (JP) 2003-341170

(51) Int. Cl. G06F 17/50

(52) U.S. Cl. 703/13

(57) ABSTRACT

A fuel cell simulator is provided which helps to present guidelines for improving performance when analyzing the causes of decline in performance of a fuel cell. In order to achieve the object, the fuel cell simulator according to the present invention displays separately the activation overvoltage, the concentration overvoltage, and the resistance overvoltage, as respective components of the overvoltage. By displaying the respective components of the overvoltage separately, the amount of the loss accounted for respectively by the activation overvoltage, the concentration overvoltage and the resistance overvoltage of the overall loss can be identified readily, thereby serving to present guidelines for improving performance, when analyzing the causes of decline in performance in a fuel cell.

### BACKGROUND

The present invention relates to fuel cell simulator, a simulation result display method, and a computer program product, for simulating the power generation characteristics of a fuel cell, and more particularly to an improvement technology suitable for assisting with analysis of fuel cells.

In analyzing the power generation characteristics of a fuel cell, it is very important to identify the internal state of the cell during power generation, such as the I-V characteristics, the current density distribution, the gas density distribution, the temperature distribution, and the like. It is not necessarily straightforward to assess the internal state of a cell during power generation, and therefore power generation characteristics are generally analyzed by using a numerical simulation technique, wherein the dynamic properties of the fuel cell are converted into a logical model. For example, Japanese Patent Laid-open No. Hei 6-188020 proposes a simulation model that is suitable for dynamic analysis of a fuel cell system.

### SUMMARY

However, conventional fuel cell simulators have had various insufficiencies with regard to discovering and analyzing the causes of decline in performance in fuel cells, and resolving these causes. For example, it is known that if a fuel cell is operated and a current is drawn from the fuel cell, then due to polarization effects, the output voltage of the fuel cell will fall by the overvoltage η, this overvoltage η being the sum of an activation overvoltage ηₐ, a concentration overvoltage η_{c} and a resistance overvoltage ηᵣ. In a conventional fuel cell simulator, when a numerical simulation of the power generation characteristics is carried out, although a function for displaying the I-V characteristics, which indicates the ultimate performance of the cell, is provided, no function is provided for displaying the respective components of the overvoltage η, namely, the respective levels of the activation overvoltage ηₐ, the concentration overvoltage η_{c}, and the resistance overvoltage ηᵣ in the overvoltage η, in a visually conceivable manner.

Therefore, it is an object of the present invention to resolve the aforementioned problem by providing a fuel cell simulator, a simulation result display method, and a computer program product, which serves to present guidelines for improving performance, when analyzing the causes of decline in performance in a fuel cell.

In order to achieve the aforementioned object, the fuel cell simulator is according to the present invention comprises an overvoltage calculating section for calculating the overvoltage of the fuel cell, and an overvoltage display section for displaying the component of the overvoltage. By displaying the respective components of the overvoltage, it is possible to provide presentation of guidelines for improving performance, when analyzing the causes of performance decline in a fuel cell.

The fuel cell simulator according to the present invention comprises: an overvoltage calculating section for calculating the overvoltage in a fuel cell by dividing the overvoltage into the activation overvoltage, the concentration overvoltage and the resistance overvoltage, respectively; and an overvoltage display section for displaying the activation overvoltage, the concentration overvoltage, and the resistance overvoltage, separately, as the component of the overvoltage. Displaying the activation overvoltage, the concentration overvoltage and the resistance overvoltage separately, as respective components of the overvoltage, facilitates analysis of the causes of decline in performance and helps to present guidelines for improving performance.

The fuel cell simulator according to the present invention comprises: an overvoltage calculating section for calculating the overvoltage in a fuel cell by dividing the voltage into the activation overvoltage, the concentration overvoltage and the resistance overvoltage, respectively; and an overvoltage display section for displaying any one selected from the activation overvoltage, the concentration overvoltage, and the resistance overvoltage. Displaying any one selected from the activation overvoltage, the concentration overvoltage, and the resistance overvoltage facilitates analysis of the causes of decline in performance and helps to present guidelines for improving performance.

The fuel cell simulator according to the present invention further comprises: a selection screen display section for displaying a selection screen for guiding an operator to select which of the activation overvoltage, the concentration overvoltage and the resistance overvoltage is to be displayed; and an input section for enabling the operator to input in accordance with the guidance of the selection screen; wherein the overvoltage display section displays any one selected by the operator from the activation overvoltage, the concentration overvoltage and the resistance overvoltage. Allowing the operator to determine which of the activation overvoltage, the concentration overvoltage and the resistance overvoltage is to be displayed makes it possible to improve usability in performance analysis.

The simulation result display method according to the present invention comprises the steps of: calculating the overvoltage of a fuel cell; and displaying the component of the overvoltage. Displaying the respective components of the overvoltage helps to present guidelines for improving performance, when analyzing the causes of decline in performance in a fuel cell.

The simulation result display method according to the present invention comprises the steps of: calculating the overvoltage in a fuel cell by dividing the overvoltage into the activation overvoltage, the concentration overvoltage and the resistance overvoltage, respectively; and displaying the activation overvoltage, the concentration overvoltage, and the resistance overvoltage, separately, as the component of the overvoltage. Displaying the activation overvoltage, the concentration overvoltage, and the resistance overvoltage separately, as the component of the overvoltage, facilitates analysis of the causes of decline in performance and helps to present guidelines for improving performance.

The simulation result display method according to the present invention comprises the steps of: calculating the overvoltage in a fuel cell by dividing the overvoltage into the activation overvoltage, the concentration overvoltage and the resistance overvoltage, respectively; and displaying any one selected from the activation overvoltage, the concentration overvoltage, and the resistance overvoltage. Displaying any one selected from the activation overvoltage, the concentration overvoltage and the resistance overvoltage facilitates analysis of the causes of decline in performance and helps to present guidelines for improving performance.

The simulation result display method according to the present invention comprises the steps of: calculating the overvoltage in a fuel cell by dividing the overvoltage into the activation overvoltage, the concentration overvoltage and the resistance overvoltage, respectively; displaying a selection screen for guiding an operator to select which of the activation overvoltage, the concentration overvoltage and the resistance overvoltage is to be displayed; and displaying any one selected by the operator from the activation overvoltage, the concentration overvoltage and the resistance overvoltage. Allowing the operator to judge which of the activation overvoltage, the concentration overvoltage and the resistance overvoltage is to be displayed makes it possible to improve usability in performance analysis.

The computer program product according to the present invention is a computer program product wherein a program for causing a computer system to simulate power generation characteristics of a fuel cell is recorded on a computer-readable recording medium; wherein the computer program is a computer program for executing the simulation result display method according to the present invention.

### DESCRIPTION OF DRAWINGS

FIG. 1 is an I-V characteristics graph calculated by a fuel cell simulator;

FIG. 2 is a functional block diagram of a fuel cell simulator;

FIG. 3 is a calculation routine for calculating overvoltage in respective cells;

FIG. 4 is a screen display routine for displaying overvoltage;

FIG. 5A to FIG. 5C are I-V characteristics graphs for respective overvoltages;

FIG. 6 shows the distribution of resistance overvoltage within a cell;

FIG. 7 is a schematic diagram of a cell; and

FIG. 8A to FIG. 8C are numerical graphs of the respective overvoltages.

### DETAILED DESCRIPTION

Below, a preferred embodiment of the present invention is described with reference to the drawings.

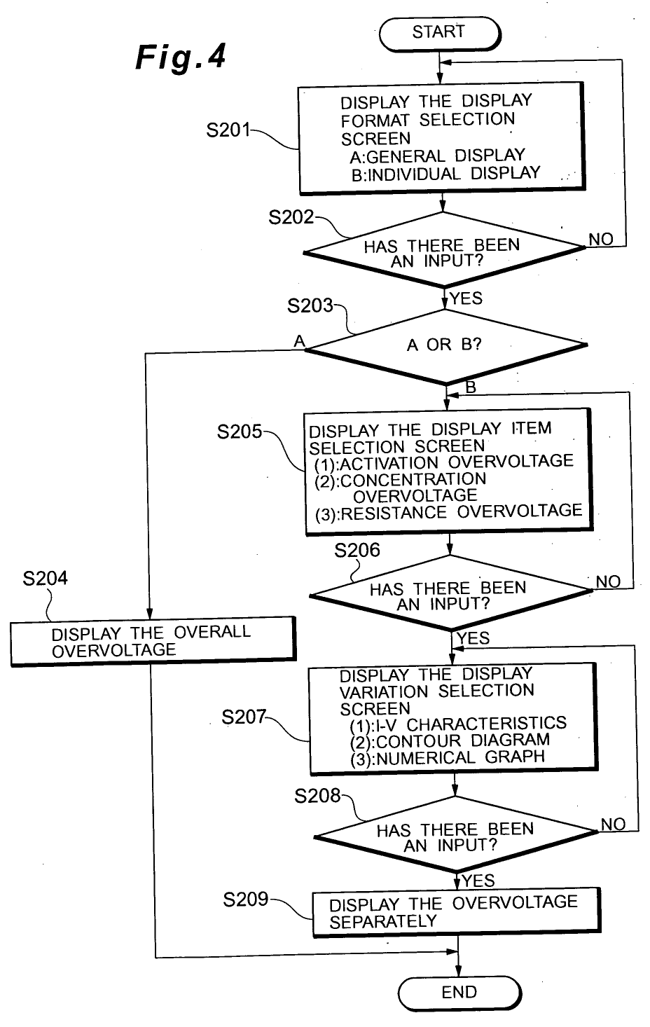

FIG. 2 is a functional block diagram of a fuel cell simulator 10 relating to the present embodiment. The simulator 10 comprises an overvoltage calculating section 11 for calculating the overvoltage η in each cell, respectively, in terms of the activation overvoltage ηₐ, the concentration overvoltage η_{c}, and the resistance overvoltage ηᵣ, a selection screen display section 12 for executing processing for displaying a screen for guiding an operator through selection of an overvoltage display format, and the like, (the processing in steps S201, S205 and S207 in FIG. 4), an input section 13 operated by the operator in accordance with the guidance provided on the selection screens, and an overvoltage display section 14 for displaying an overvoltage in a designated display format, or the like. In this specification, “overvoltage” is taken to have the same meaning as “voltage loss”.

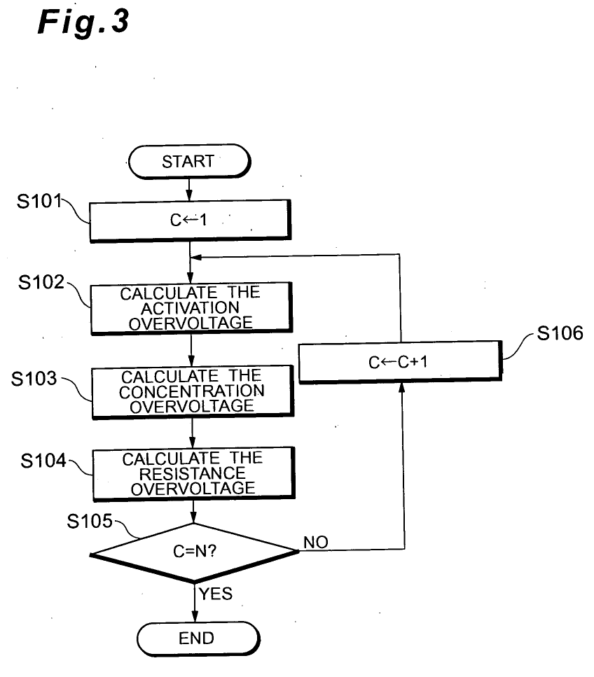

FIG. 3 shows a calculation routine for calculating overvoltage in each respective cell. When this calculation routine is called, the overvoltage calculating section 11 firstly substitutes 1 as an initial value for the variable C which counts the number of cells being calculated (step S101). The value of the variable C is incremented by 1, each time the loop processing consisting of step S102 to step S106 is performed. Thereupon, calculations are made for the Cth cell, in the order is of, activation overvoltage ηₐ, concentration overvoltage η_{c}, and resistance overvoltage ηᵣ (steps S102-S104). These respective overvoltages can be calculated by means of Equation (1) to Equation (3).
ηₐ=a−b×logI (1)
η_{c}=b×log(1−I/I_{L}) (2)
ηᵣ=IR (3)

Here, a and b are constants, R is a resistance value, I is a current density, and I_{L} is the limiting current density.

When the calculations for the respective overvoltages have been completed, it is checked whether or not calculation has been completed for all of the cells (step S105). Here, if the number of cells of the fuel cell is taken to be N, then it is checked whether or not C=N. If C<N, (NO at step S105), then this means that there still remain cells for which calculations have not been made, and the variable C is incremented by one (step S106), whereupon the procedure returns to step S102. The aforementioned steps are repeated, and when the overvoltage calculations have been completed for all of the cells (YES at step S105), then the calculation routine terminates.

In order to analyze the respective components of the overvoltage η in detail, a composition may also be adopted wherein the activation overvoltage ηₐ is divided and calculated separately in terms of the anode activation overvoltage and the cathode activation overvoltage, in such a manner that each can be displayed in a separate fashion. Providing a display which makes it possible readily to tell, visually, the respective levels of anode activation overvoltage and cathode activation overvoltage contained in the overall overvoltage η helps to assist analysis of the fuel cell. In a similar manner, a composition can also be adopted wherein the concentration overvoltage η_{c} is divided and calculated separately as the anode concentration overvoltage and the cathode concentration overvoltage, in such a manner that each can be displayed in a separate fashion. Furthermore, a composition can also be adopted whereby the resistance overvoltage ηᵣ is divided and calculated separately in terms of the MEA resistance overvoltage, the diffusion layer resistance overvoltage, and the current collector resistance overvoltage, in such a manner that each can be displayed in a separate fashion.

FIG. 4 shows a screen display routine which describes a processing sequence for displaying the calculation results for the respective overvoltages (a simulation result display method). The display format for overvoltages may be one which displays the respective levels of each of the overvoltages (activation overvoltage ηₐ, concentration overvoltage η_{c}, resistance overvoltage ηᵣ) contained in the overall overvoltage η (hereinafter, called a “general display”), or one which extracts and displays the respective overvoltages (activation overvoltage ηₐ, concentration overvoltage η_{c}, resistance overvoltage ηᵣ) in an individual fashion (hereinafter, called “individual display”). When this routine is called, the selection screen display section 14 displays the display format selection screen (step S201). The display format selection screen is a screen for guiding the operator of the fuel cell simulator 10 to select either “A: General display” or “B: Individual display”. Here, if the operator operates the input section 12 and enters either “A: General display” or “B: Individual display”, (YES at step S202), then the selection screen display section 14 checks which out of “A: General display” and “B: Individual display” has been specified (step S203).

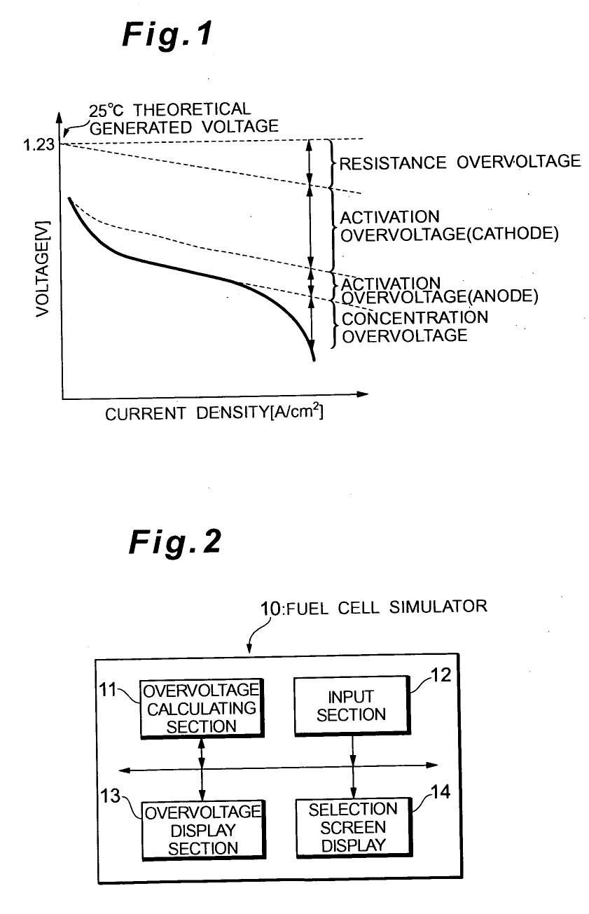

If “A: General display” has been selected (A at step S203), then the overvoltage display section 13 implements “general display”, as shown in FIG. 1 (step S204). This diagram illustrates an I-V characteristics graph for a fuel cell, and it provides a readily comprehensible visual display of the respective components of the various losses with respect to the theoretical generated voltage of 1.23 V at 25° C. (namely, the resistance overvoltage, the activation overvoltage (cathode), the activation overvoltage (anode), and the concentration overvoltage). By displaying the respective components of the overvoltage η in this way, the causes of decline in performance become evident, thereby helping to present guidelines for improving performance. If the display mode of the “general display” is set to allow the respective causes of voltage losses (activation overvoltage, concentration overvoltage and resistance overvoltage) to be displayed visually in a separated fashion, then various display modes providing excellent convenience for analysis purposes can be adopted, rather than being limited to displaying causes relating to I-V characteristics only, as shown in FIG. 1.

On the other hand, if “B: Individual display” is selected (B at step S203), then the selection screen display section 14 displays a screen for selecting which type of overvoltage, from the activation overvoltage, concentration overvoltage, and resistance overvoltage, is to be displayed (step S205). Here, three items, namely, the activation overvoltage, the concentration overvoltage and the resistance overvoltage are described as examples of display items, but it is also possible to display the respective components of each type of overvoltage in a more detailed fashion, namely, activation overvoltage (anode), activation overvoltage (cathode), concentration overvoltage (anode), concentration overvoltage (cathode), MEA resistance overvoltage, diffusion layer resistance overvoltage, and current collector resistance overvoltage. Here, if one of the display items is selected by means of the operator operating the input section 12 (YES at step S206), then the selection screen display section 14 displays a display variation selection screen (step S207). The display variation selection screen is a screen for guiding the selection of a display variation for each of the overvoltages. Here, it is selected from (1) I-V characteristics, (2) contour diagram (distribution diagram), and (3) numerical graph (distribution values). If the operator selects one of the display variations by operating the input section 12 (YES at step S208), then the overvoltage display section 13 performs an “individual display” corresponding to the display variation thus selected (step S209).

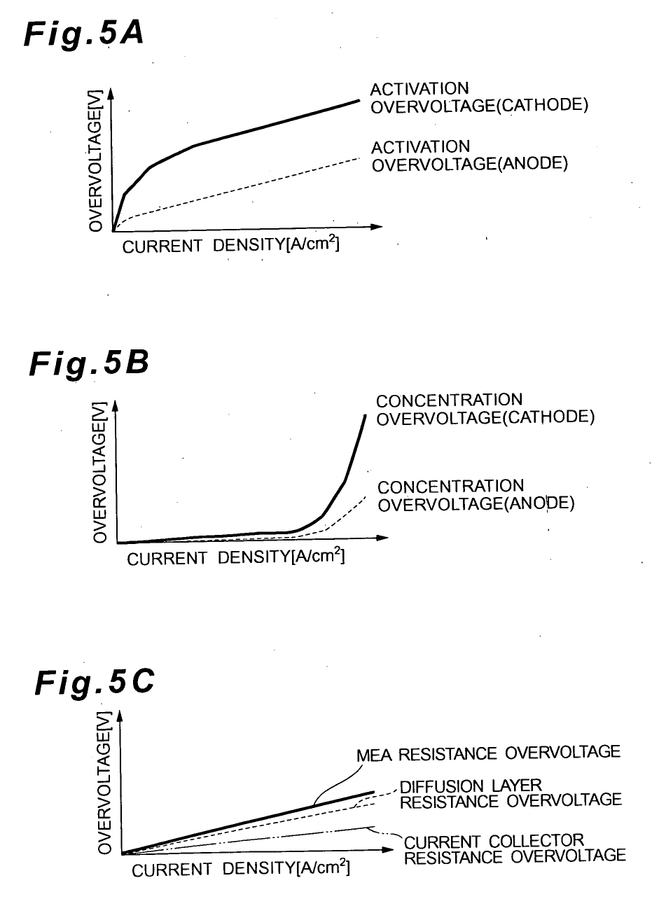

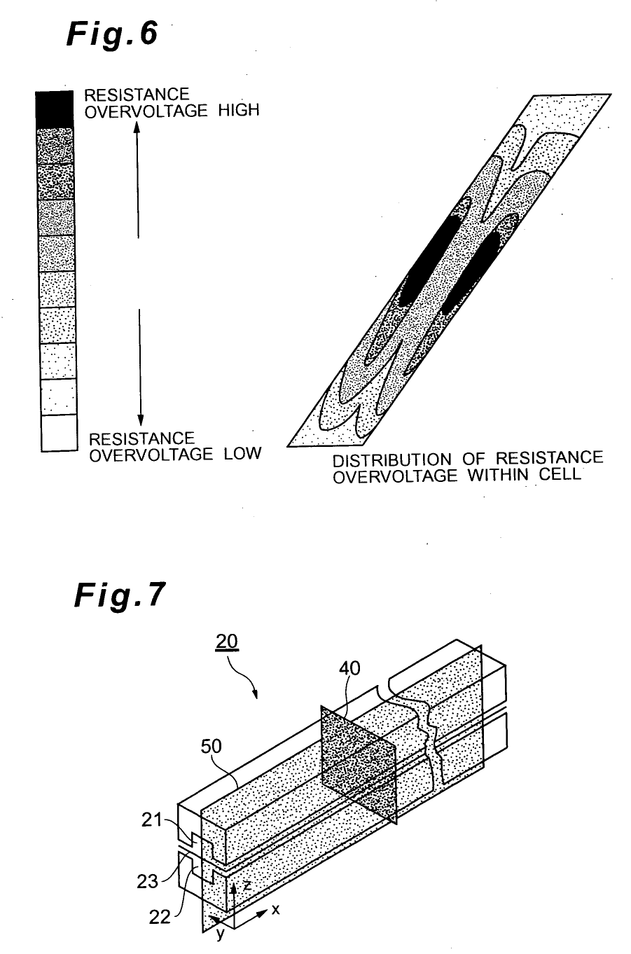

For example, if the operator selects the I-V characteristics at step S207, then as shown in FIG. 5, the I-V characteristics for each overvoltage are displayed. FIG. 5A shows the activation overvoltage, FIG. 5B shows the concentration overvoltage, and FIG. 5C shows the resistance overvoltage. In this way, by displaying the I-V characteristics separately with respect to each of the types of overvoltage, it is possible to identify what degree of loss exists within what current range, which is highly appropriate for analyzing the performance of a fuel cell. On the other hand, if the operator selects the contour diagram option, then contour diagrams are displayed for the respective types of overvoltage, as shown in FIG. 6. These diagrams show the resistance overvoltage inside the cell. Being able to identify the distribution of the overvoltage within the cell in this way helps to analyze the power generation characteristics.

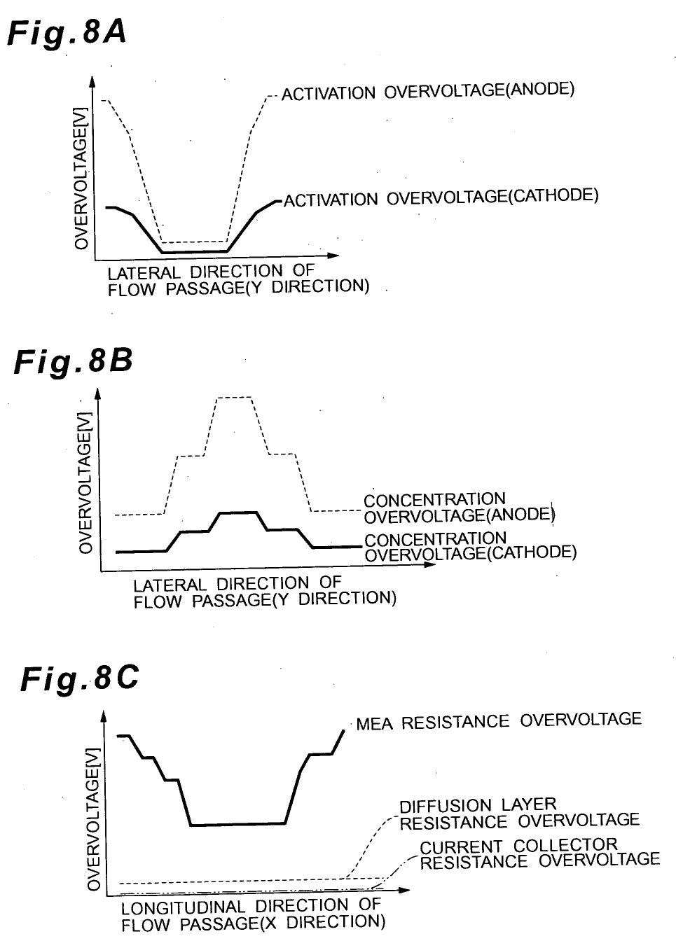

Separately from this, if the operator selects a numerical graph, then numerical graphs for the respective overvoltages are displayed, as shown in FIG. 8. This numerical graph is obtained by expressing the overvoltage in the YZ plane 40 or the XZ plane 50, in numerical form, when the direction of a gas flow passage in the cell 20 consisting of an anode gas channel 21, a cathode gas channel 22 and a film and electrode compound 23 is taken as direction X, the lateral direction of the flow passage is taken as direction Y, and the direction in which the current flows in the film and electrode compound 23 is taken as direction Z, as shown in FIG. 7. Here, FIG. 8A shows the activation overvoltage in the lateral direction of the flow passage (Y direction) of the cell 20 in the YZ plane 40, FIG. 8B shows the concentration overvoltage in the lateral direction of the flow passage (Y direction) of the cell 20 in the same YZ plane, and FIG. 8C shows the resistance overvoltage in the longitudinal direction of the flow passage (X direction) of the cell 20 in the XZ plane 50. Expressing the respective overvoltages in numerical form with respect to various cross-sections of the cell 20, and displaying them in a visually identifiable manner in this way, helps to analyze the power generation characteristics.

As described above, according to the present embodiment, the activation overvoltage, the concentration overvoltage and the resistance overvoltage are displayed separately as respective components of the overvoltage η, and therefore it is possible to identify the amount of the total loss accounted for respectively by each of the activation overvoltage, the concentration overvoltage and the resistance overvoltage, and this in turn helps to present guidelines for improving performance, when the causes of decline in performance of a fuel cell are analyzed. Moreover, by preparing a plurality of display variations wherein the respective overvoltages are represented from a plurality of angles, it is possible to analyze the power generation characteristics from many different viewpoints.

In the foregoing description, a fuel cell simulator 10 was explained, but according to the present invention, it is also possible to provide a computer program product wherein a program for causing the simulation result display method described above to be executed in a computer system is recorded on a computer-readable recording medium.

The entire disclosure of Japanese Patent Laid-open No. 6-188020 filed on 8 Jul. 1994 including specification, claims, drawings and summary are herein by reference in it entirely.

1. A fuel cell simulator comprising:
an overvoltage calculating section for calculating an overvoltage in a fuel cell; and
an overvoltage display section for displaying a component of the overvoltage.

2. The fuel cell simulator according to claim 1, wherein said overvoltage calculating section calculates the overvoltage in the fuel cell by dividing the overvoltage into an activation overvoltage, a concentration overvoltage and a resistance overvoltage, respectively, and said overvoltage display section displays the activation overvoltage, the concentration overvoltage, and the resistance overvoltage, separately, as a component of the overvoltage.

3. The fuel cell simulator according to claim 1, wherein said overvoltage calculating section calculates the overvoltage in the fuel cell by dividing the overvoltage into an activation overvoltage, a concentration overvoltage and a resistance overvoltage, respectively, and said overvoltage display section displays any one selected from the activation overvoltage, the concentration overvoltage, and the resistance overvoltage.

4. The fuel cell simulator according to claim 1, further comprising:
a selection screen display section for displaying a selection screen for guiding an operator to select which of the activation overvoltage, the concentration overvoltage and the resistance overvoltage is to be displayed; and
an input section for enabling the operator to input in accordance with the guidance of the selection screen;
wherein said overvoltage calculating section calculates the overvoltage in the fuel cell by dividing the overvoltage into an activation overvoltage, a concentration overvoltage and a resistance overvoltage, respectively, and said overvoltage display section displays any one selected by the operator from the activation overvoltage, the concentration overvoltage, and the resistance overvoltage.

5. The fuel cell simulator according to claim 1, wherein said overvoltage display section displays the the component of the overvoltage based on I-V characteristics, contour diagram, or numerical graph.

6. A simulation result display method comprising the steps of:
calculating an overvoltage of a fuel cell; and
displaying a component of the overvoltage.

7. The simulation result display method according to claim 6, wherein said step of calculating the overvoltage further includes the step of calculating the overvoltage in the fuel cell by dividing the overvoltage into an activation overvoltage, a concentration overvoltage and a resistance overvoltage, respectively; and said step of displaying a component of the overvoltage further includes the step of displaying the activation overvoltage, the concentration overvoltage, and the resistance overvoltage, separately, as a component of the overvoltage.

8. The simulation result display method according to claim 6, wherein said step of calculating the overvoltage further includes the step of calculating the overvoltage in the fuel cell by dividing the overvoltage into an activation overvoltage, a concentration overvoltage and a resistance overvoltage, respectively; and said step of displaying a component of the overvoltage further includes the step of displaying any one selected from the activation overvoltage, the concentration overvoltage, and the resistance overvoltage.

9. The simulation result display method according to claim 6, wherein said step of calculating the overvoltage further includes the step of calculating the overvoltage in the fuel cell by dividing the overvoltage into an activation overvoltage, a concentration overvoltage and a resistance overvoltage; respectively; and said step of displaying the component of the overvoltage further includes the steps of displaying a selection screen for guiding an operator to select which of the activation overvoltage, the concentration overvoltage and the resistance overvoltage is to be displayed; and displaying any one selected by the operator from the activation overvoltage, the concentration overvoltage and the resistance overvoltage.

10. The simulation result display method according to claim 6, wherein said step of displaying the component of the overvoltage further includes the step of displaying the component of the overvoltage based on I-V characteristics, contour diagram, or numerical graph.

11. A computer program product wherein a program for causing a computer system to simulate power generation characteristics of a fuel cell is recorded on a computer-readable recording medium;
wherein the computer program is a computer program for executing the simulation result display method according to claims 6.

12. A computer program product wherein a program for causing a computer system to simulate power generation characteristics of a fuel cell is recorded on a computer-readable recording medium;
wherein the computer program is a computer program for executing the simulation result display method according to claims 7.

13. A computer program product wherein a program for causing a computer system to simulate power generation characteristics of a fuel cell is recorded on a computer-readable recording medium;
wherein the computer program is a computer program for executing the simulation result display method according to of claims 8.

14. A computer program product wherein a program for causing a computer system to simulate power generation characteristics of a fuel cell is recorded on a computer-readable recording medium;
wherein the computer program is a computer program for executing the simulation result display method according to claims 9.

15. A computer program product wherein a program for causing a computer system to simulate power generation characteristics of a fuel cell is recorded on a computer-readable recording medium;
wherein the computer program is a computer program for executing the simulation result display method according to claims 10.
